(19) United States
(12) Patent Application Publication
(10) Pub. No.: US 2008/0089264 A1
(43) Pub. Date: Apr. 17, 2008

(54) APPARATUS AND METHOD FOR PROVIDING NEWS SERVICE USING MULTICAST AND BROADCAST SERVICE IN BROADBAND WIRELESS ACCESS SYSTEM

(75) Inventors: Jun-Hyung KIM, Suwon-si (KR); Nae-Hyun LIM, Yongin-si (KR); Yong Chang, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/871,717

(22) Filed: Oct. 12, 2007

(30) Foreign Application Priority Data
Oct. 12, 2006 (KR) 2006-0099157

(51) Int. Cl. H04H 20/71; H04L 29/08

(52) U.S. Cl. 370/312; 455/414.3

(57) ABSTRACT

Provided is an apparatus and method for providing a news service using an MBS in a BWA system. In a method for providing a news service from a newsgroup server in a wireless access system, if a user terminal has joined at least one newsgroup, a message for notifying an MBSC of a newsgroup subscription of the user terminal, in order to allocate a newsgroup dedicated MCID to the user terminal. News contents are received from a news provider corresponding to the at least one newsgroup. The received news contents are created into one packet and the resulting news packet is transmitted to the MBSC in real time or at a predetermined period of time.

### PRIORITY

This application claims priority under 35 U.S.C. § 119(a) to a Korean Patent Application filed in the Korean Intellectual Property Office on Oct. 12, 2006 and assigned Serial No. 2006-0099157, the contents of which are incorporated herein by reference.

### BACKGROUND OF THE INVENTION

1. Field of the Invention

The present invention relates generally to a Multicast and Broadcast Service (MBS), and in particular, to an apparatus and method for providing a news service using an MBS in a Broadband Wireless Access (BWA) system.

2. Description of the Related Art

As generally known in the art, communication systems have been primarily developed for voice communication services, but communication systems are also evolving to provide data services and various multimedia services. However, conventional communication systems, which are mainly directed to providing voice communication services, still have a narrow data transmission bandwidth and require a high subscription fee. For these reasons, they cannot satisfy diversified user demands. Furthermore, in line with the rapid development of the communication industry and ever-increasing demands on Internet services, it is important to provide communication systems capable of providing Internet services efficiently. As a result of these trends, BWA systems having a bandwidth large enough to both satisfy the increasing user demands and provide efficient Internet services have been proposed.

In addition to providing voice communication services, BWA systems also aim to support various data services both at low and high speeds and multimedia application services (e.g., high-quality video) in combination. BWA systems are based on wireless media using a 2 GHz, 5 GHz, 26 GHz, or 60 GHz broadband and are able to access a Public Switched Telephone Network (PSTN), a Public Switched Data Network (PSDN), Internet network, an International Mobile Telecommunications-2000 (IMT-2000) network, and an Asynchronous Transfer Mode (ATM) network in either a mobile or stationary environment. In other words, BWA systems are wireless communication systems capable of supporting a channel transmission rate of at least 2 Mbps. BWA systems may be classified into broadband wireless local loops, broadband mobile access networks, and high-speed wireless Local Area Networks (LANs) according to the terminal's mobility (stationary or mobile), communication environment (indoor or outdoor) and channel transmission rate.

The standardization of wireless access schemes of BWA systems is being conducted by the Institute of Electrical and Electronics Engineers (IEEE), which is one of the international standardization organizations, particularly by the IEEE 802.16 standardization group.

Compared with conventional communication systems for voice communication services, IEEE 802.16 communication systems have a larger data transmission bandwidth. Therefore, the IEEE 802.16 communication systems can transmit more data for a limited period of time and share all user channels (or resources) for efficient channel utilization. Also, since Quality of Service (QoS) features are guaranteed, users can be provided with various services of different qualities depending on the characteristics of services.

The IEEE 802.16 system has Multicast and Broadcast Service (MBS) standards for providing MBS services to a plurality of mobile terminals. In the MBS standards, the same MBS zone is divided using different Connection IDentifiers (CIDs) or different Security Associations (SAs). An MBS zone (MBS_ZONE) is used to indicate a zone where an MBS service flow is available through the CID and the SA, and a Base Station (BS) broadcasts MBS zone information through a Downlink Channel Descriptor (DCD) message. That is, the MBS zone can be called a BS group that uses the same CID and the same SA to transmit contents.

The MBS service is used to broadcast or multicast broadcast contents to all user terminals within an MBS zone providing a predetermined broadcast service. Based on the characteristics of the IEEE 802.16 system, the MBS service can provide not only a downlink unidirectional broadcast service but also an uplink bidirectional service.

Really Simple Syndication, or Rich Site Summary, (RSS) is a kind of transfer protocol, which is a standard communication format based on an eXtensible Markup Language (XML). Various contents can be summarized and shared through the RSS, and whether a desired site has been updated can be easily detected in real time through a user program supporting the RSS.

With the widespread use of various digital devices, the production of personal media contents is gradually promoted and there is a great increase in the demand of users for the distribution and broadcast of the personal media contents and an increase in the demand of users to receive data, even while the users move from one location to another. Therefore, a method is required for automatically receiving updated data by detecting updates of multimedia clip services or news services, which are personally produced or provided by sites, even while users move from one location to another.

### SUMMARY OF THE INVENTION

An object of the present invention is to substantially solve at least the above problems and/or disadvantages and to provide at least the advantages below. Accordingly, an object of the present invention is to provide an apparatus and method for providing a news service using a Multicast and Broadcast Service (MBS) in a Broadband Wireless Access (BWA) system.

Another object of the present invention is to provide an apparatus and method for providing users with news services using a Really Simple Sydication (RSS) function in a BWA system.

Still another object of the present invention is to provide an apparatus and method for providing a news service using an MBS in a BWA system, which enables a user terminal, subscribed to a newsgroup, to detect an updated news service in real time without the user's intervention.

According to one aspect of the present invention, a method for providing a news service from a newsgroup server in a wireless access system includes if a user terminal has joined at least one newsgroup, transmitting a message for notifying an MBS Controller (MBSC) of a newsgroup subscription of the user terminal, in order to allocate a newsgroup dedicated Multicast Connection IDentification (MCID) to the user terminal; receiving news contents from a news provider corresponding to the at least one newsgroup; and creating the received news contents into one packet and transmitting the resulting packet to the MBSC in real time or at a predetermined period of time.

According to another aspect of the present invention, a method for providing a news service from an MBSC in a wireless access system includes upon receiving a message for notifying an MSBC of a newsgroup subscription of a user terminal from a newsgroup server, allocating a newsgroup dedicated MCID to the user terminal; and upon receiving news contents for at least one newsgroup, which are created into one packet, from the newsgroup server in real time or at a predetermined period of time, multicasting the received news contents to the user terminal through an MCID.

According to still another aspect of the present invention, an apparatus for providing a news service in a wireless access system includes a newsgroup server for, if a user terminal has joined at least one newsgroup, transmitting a message for notifying an MBSC of a newsgroup subscription of the user terminal, receiving news contents from a news provider corresponding to the at least one newsgroups, creating the received news contents into one packet, and transmitting the resulting news packet to the MBSC in real time or at a predetermined period of time; and the MBSC for allocating a newsgroup dedicated MCID to the user terminal upon receiving a message for notifying the newsgroup subscription of the user terminal from the newsgroup server, receiving the news contents created into one packet from the newsgroup server, and multicasting the received news contents to the user terminal through an MCID.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a network for providing a news service using an MBS in a BWA system according to an embodiment of the present invention;

FIG. 2 is a flow diagram illustrating a procedure for providing a news service to a user terminal of a newsgroup subscriber using an MBS in a BWA system according to an embodiment of the present invention;

FIG. 3 is a flowchart illustrating a procedure for providing a news service from a newsgroup server to a user terminal of a newsgroup subscriber using an MBS in a BWA system according to an embodiment of the present invention; and

FIG. 4 is a flowchart illustrating a procedure for providing a news service from an MBS controller to a user terminal of a newsgroup subscriber using an MBS in a BWA system according to an embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for providing a news service using a Multicast and Broadcast Service (MBS) in a Broadband Wireless Access (BWA) system. Embodiments of the present invention provide an apparatus and method for providing a news service to a newsgroup subscriber using an MBS in the Institute of Electrical and Electronics Engineers (IEEE) 802.16 system.

In the following explanations, the name of a Network Entity (NE) is defined according to its corresponding function, and thus the name may vary according to an intention of a standard group or an operator. For example, the BS may be called a Radio Access Station (RAS), and a BS controller may be called an Access Control Router (ACR) or an Access Service Network-Gateway (ASN-GW). Herein, the ASN-GW can function as a BS controller as well as a router. Also, The Multicast and Broadcast Service (MBS) may be called a MultiCast and BroadCast Service (MCBCS), and an MBS Controller (MBSC) may be called an MBS Network Server (MBS NS) or an MCBCS Network Server (MCBCS NS) according to an intention of a standard group or an operator.

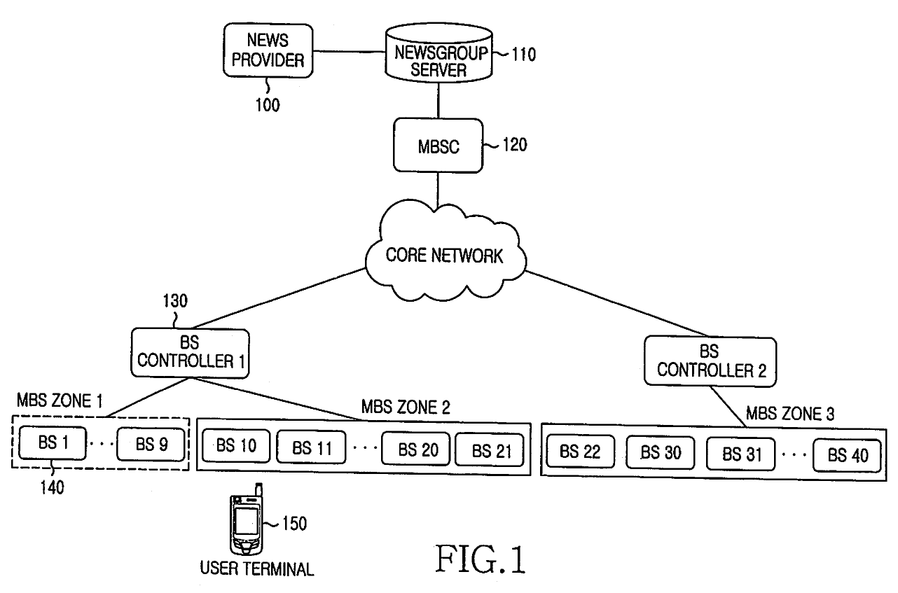

FIG. 1 is a block diagram of a network for providing a news service using an MBS in a BWA system according to an embodiment of the present invention.

Referring to FIG. 1, the network includes a news provider 100, a newsgroup server 110, an MBS Controller (MBSC) 120, a first Base Station (BS) controller 130, a first BS 140, and a user terminal 150.

The news provider 100 is a content provider that provides news contents. The news provider 100 creates news contents and uploads the created contents into the newsgroup server 110.

The newsgroup server 110 stores the news contents provided from the news provider 100, and multiplexes/transmits the stored contents to the MBSC 120 in real time or at a predetermined period of time. Also, the newsgroup server 110 manages a newsgroup list and data of newsgroup subscribers subscribed to the newsgroup.

The MBSC 120 receives the multiplexed news contents from the newsgroup server 110, requests a burst allocation to the BS controller 130 to allocate resources for transmitting the received news contents to the user terminal 150, packetizes the received news contents into a packet of a predetermined size, performs an inter-BS time synchronization, and multicasts the received news contents to the user terminal 150. Also, if there is a new newsgroup subscriber, the MBSC 120 allocates the new newsgroup subscriber a newsgroup dedicated Multicast Connection IDentification (MCID) and transmits the allocated MCID to the BS 140 where the subscriber is located.

The BS controller 130 transmits a message received from the MBSC 120 to the BS 140. The BS 140 performs wireless communication with the user terminal 150, establishes an MBS connection with the user terminal 150 upon receiving the MCID for the newsgroup subscriber, and allocates a burst to the user terminal 150 upon receiving the burst allocation request from the MBSC 120.

The user terminal 150 receives news contents by demultiplexing the multiplexed packet received form the MBSC 120. As illustrated in FIG. 1, an MBS zone includes a plurality of BSs, and all of the BSs in the same MBS zone transmit the same broadcast signal simultaneously.

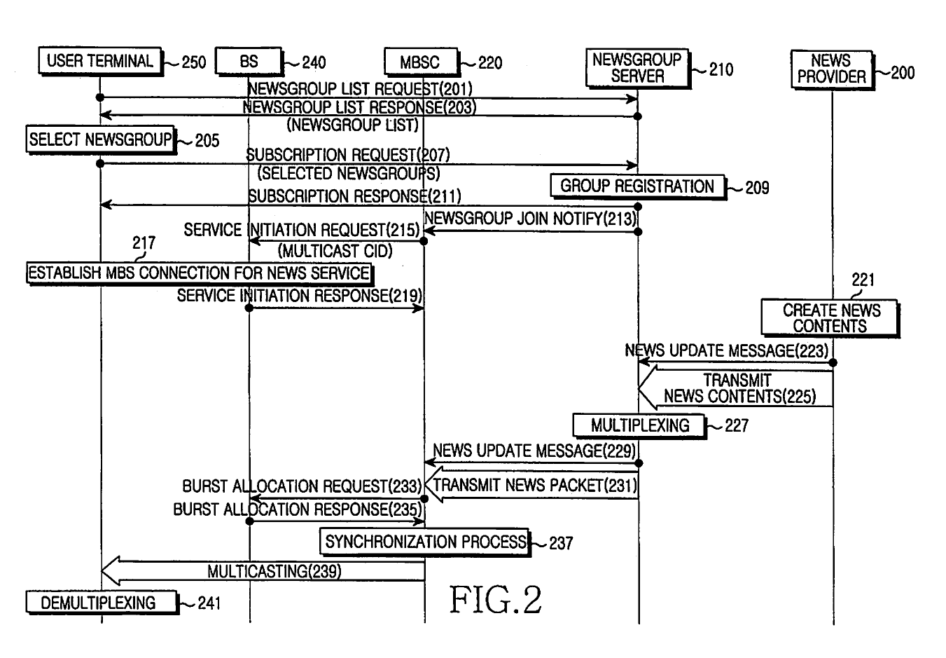

FIG. 2 is a flow diagram illustrating a procedure for providing a news service to a user terminal of a newsgroup subscriber using an MBS in a BWA system according to an embodiment of the present invention.

Referring to FIG. 2, a user terminal 250 transmits a newsgroup list request message for newsgroup subscription to a newsgroup server 210 in step 201. In step 203, the newsgroup server 210 transmits a newsgroup list response message including an available newsgroup list to the user terminal 250.

In step 205, the user terminal 250 selects at least one desired newsgroup from the newsgroup list. In step 207, the user terminal 250 transmits a subscription request message for the selected newsgroups to the newsgroup server 210. In step 209, the newsgroup server 210 adds the user terminal 250 to a subscriber list of the requested newsgroups and performs a group registration. In step 211, the newsgroup server 210 transmits a subscription response message to the user terminal 250 to notify the user terminal 250 of the subscription results of the newsgroups.

In step 213, the newsgroup server 210 transmits a newsgroup join notify message to an MBSC 220 to notify the MBSC 220 that the user terminal 250 has joined the newsgroup. In step 215, the MBSC 220 allocates a newsgroup dedicated MCID so that the user terminal 250 subscribed to the newsgroup can receive a news service through an MBS connection, and transmits a service initiation request message including the allocated MCID to a BS 240 where the user terminal 250 is located, so that the BS 240 establishes an MBS connection with the user terminal 250. In step 217, the BS 240 establishes an MBS connection with the user terminal 250 to provide a news service. In step 219, the BS 240 transmits a service initiation response message to the MBSC 220 to notify the MBSC 220 of the MBS connection establishment results. The MBS connection is a newsgroup-dedicated channel that is used to provide all news contents to the corresponding user terminal through one MCID without establishing a connection with each newsgroup.

In step 221, a news provider 200 creates new news contents. In step 223, the news provider 200 transmits a news update message to the newsgroup server 210 to upload the created news contents. In step 225, the news provider 200 transmits the created news contents to the newsgroup server 210.

In step 227, the newsgroup server 210 multiplexes news contents, which are received from a plurality of the news providers 200 corresponding to the newsgroup selected by the user terminal 250, into one packet. In step 229, the newsgroup server 210 transmits a news update message to the MBSC 220 in order to provide the updated news contents to the user terminal 250. In step 231, the newsgroup server 210 transmits the multiplexed packet to the MBSC 220. The multiplexing process may be performed in real time or at a predetermined period of time after buffering of at least one news contents.

In step 233, the MBSC 220 transmits a burst allocation request message to the BS 240 in order to allocate resources for transmitting the created news contents to the user terminal 250. In step 235, the BS 240 allocates the user terminal 250 a burst for transmission of news contents and transmits a burst allocation response message to the MBSC 220.

In step 237, the MBSC 220 packetizes the received packet into a packet of a predetermined size and performs a time synchronization between BSs 240. In step 239, the MBSC 220 multicasts the packetized news contents to user terminals 250 subscribed to the corresponding newsgroup by using the MCID. In step 241, the user terminal 250 receives a plurality of news contents by demultiplexing the packet received through the MBS connection, and displays only a newsgroup of interest to the user among the received news contents by filtering.

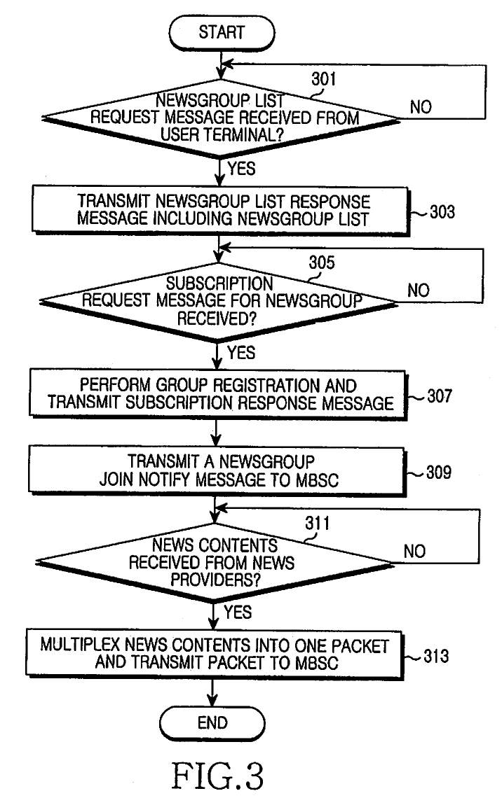

FIG. 3 is a flowchart illustrating a procedure for providing a news service from a newsgroup server to a user terminal of a newsgroup subscriber using an MBS in a BWA system according to an embodiment of the present invention.

Referring to FIG. 3, in step 301, the newsgroup server 110 determines whether a newsgroup list request message is received from the user terminal 150. If the newsgroup list request message is received, the procedure proceeds to step 303. In step 303, the newsgroup server 110 transmits a newsgroup list response message including an available newsgroup list to the user terminal 150.

In step 305, the newsgroup server 110 determines whether a subscription request message for at least one newsgroup selected from the newsgroup list is received from the user terminal 150. If the subscription request message is received, the procedure proceeds to step 307. In step 307, the newsgroup server 110 adds the user terminal 150 to a subscriber list of the requested newsgroups to perform group registration, and transmits a subscription response message to the user terminal 150 to notify the user terminal 150 of the subscription results of the newsgroups.

In step 309, the newsgroup server 110 transmits a newsgroup join notify message to the MBSC 120 to notify the MBSC 120 that the user terminal 150 has joined the newsgroup. At this point, the MBSC 120 allocates an MCID so that the user terminal 150 subscribed to the newsgroup can receive a news service through an MBS connection, and transmits a service initiation request message including the allocated MCID to the BS 140 where the user terminal 150 is located, so that the BS 140 establishes an MBS connection with the user terminal 150.

In step 311, the newsgroup server 110 determines whether news contents are received from news providers 100 corresponding to the newsgroup selected by the user terminal 150. Before receiving the news contents, the newsgroup server 110 may receive a news update message from the news providers 100 in order to upload news contents. If the news contents are received, in step 311, the procedure proceeds to step 313. In step 313, the newsgroup server 110 multiplexes the received news contents, into one packet and transmits the multiplexed packet to the MBSC 120. The multiplexing process may be performed in real time or at a predetermined period of time after buffering of at least one news contents. The newsgroup server 110 may transmit a news update message to the MBSC 120 before the transmission of the packet. Thereafter, the procedure ends.

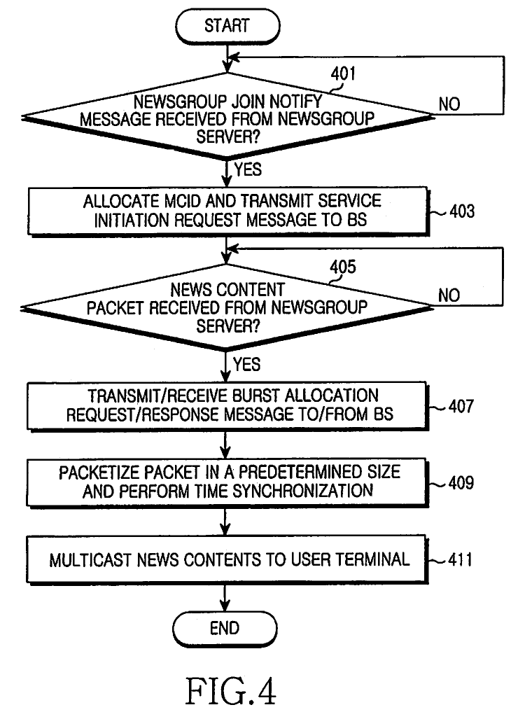

FIG. 4 is a flowchart illustrating a procedure for providing a news service from an MBS controller to a user terminal of a newsgroup subscriber using an MBS in a BWA system according to an embodiment of the present invention.

Referring to FIG. 4, in step 401 the MBSC 120 determines whether a join-newsgroup notification message for notifying that the user terminal 150 has joined a newsgroup is received from the newsgroup server 110. If the newsgroup join notify message is received, the procedure proceeds to step 403. In step 403, the MBSC 120 allocates a newsgroup dedicated MCID so that the user terminal 150 subscribed to the newsgroup can receive a news service through an MBS connection, and transmits a service initiation request message including the allocated MCID to the BS 140 where the user terminal 150 is located, so that the BS 140 establishes an MBS connection with the user terminal 150. At this point, the BS 140 may establish MBS connection with the user terminal 150 and then transmit a service initiation response message to the MBSC 120.

In step 405, the MBSC 120 determines whether the news contents multiplexed into one packet are received from the newsgroup server 110. The news contents multiplexed into one packet may be received in real time or at a predetermined period of time, and the MBSC 120 may receive a news update message from the newsgroup server 110 before receiving the packet.

If the news contents multiplexed into one packet are received (in step 405), the procedure proceeds to step 407. In step 407, the MBSC 120 transmits a burst allocation request message to the BS 140 in order to allocate resources for transmitting the news contents to the user terminal 150, and receives a burst allocation response message from the BS 140. Upon receiving the burst allocation request message, the BS 140 allocates the user terminal 150 a burst for transmission of news contents.

In step 409, the MBSC 120 packetizes the received packet into a packet of a predetermined size and performs a time synchronization between BSs 140. In step 411, the MBSC 120 multicasts the packetized news contents to user terminals 150 subscribed to the corresponding newsgroup. At this point, the user terminal 150 may receive a plurality of news contents by demultiplexing the packet, and may display only an interesting newsgroup of the user among the news contents by filtering. Thereafter, the procedure ends.

According to the present invention as described above, the news service is provided to the newsgroup subscriber using the MBS in the BWA system. Therefore, the updated data can be automatically received through the user terminal without the need to manually search and download the interesting news contents. In the conventional system, an uplink band must be allocated to search new data. However, in the present invention, downlink data are transmitted through multicasting. Therefore, a waste of resources and a delay time due to a band allocation request can be greatly reduced, and the contents of a wired network can be reused in a wireless network.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for providing a news service from a newsgroup server in a wireless access system, the method comprising:
if a user terminal has joined at least one newsgroup, transmitting a message for notifying a Multicast and Broadcast Service Controller (MBSC) of a newsgroup subscription of the user terminal, in order to allocate a newsgroup dedicated Multicast Connection IDentification (MCID) to the user terminal;
receiving news contents from a news provider corresponding to the at least one newsgroup; and
creating the received news contents into one packet and transmitting the resulting packet to the MBSC in real time or at a predetermined period of time.

2. The method of claim 1, wherein the newsgroup subscription of the user terminal comprises adding the user terminal to a subscriber list of newsgroups upon receiving a subscription request message for the at least one newsgroup from the user terminal.

3. The method of claim 1, further comprising, before the newsgroup subscription of the user terminal, transmitting a newsgroup list response message including an available newsgroup list to the user terminal upon receiving a newsgroup list request message from the user terminal.

4. The method of claim 2, further comprising transmitting a subscription response message to the user terminal to report subscription results of the newsgroups to the user terminal.

5. The method of claim 1, further comprising, before receiving the news contents, receiving a news update message from the news provider in order to upload news contents.

6. The method of claim 1, further comprising, before transmitting the resulting packet to the MBSC, transmitting a news update message to the MBSC in order to upload news contents.

7. A method for providing a news service from a Multicast and Broadcast Service Controller (MBSC) in a wireless access system, the method comprising:
upon receiving a message for notifying the MSBC of a newsgroup subscription of a user terminal from a newsgroup server, allocating a newsgroup dedicated Multicast Connection IDentification (MCID) to the user terminal; and
upon receiving news contents for at least one newsgroup, which are created into one packet, from the newsgroup server in real time or at a predetermined period of time, multicasting the received news contents to the user terminal through an MCID.

8. The method of claim 7, further comprising, before the receiving the news contents after the allocation of the MCID, receiving a news update message from the newsgroup server to upload news contents.

9. The method of claim 7, further comprising, before the multicast of the news contents to the user terminal after the receiving the news contents,
creating the received news contents into a packet of a predetermined size; and
performing time synchronization between Base Stations (BSs).

10. The method of claim 7, further comprising, before the multicast of the news contents to the user terminal after the receiving the news contents,
transmitting a burst allocation request message to a corresponding BS in order to allocate resources for transmitting the received news contents to the user terminal; and
receiving a burst allocation response message from the BS.

11. The method of claim 7, further comprising:
transmitting a service initiation request message including the allocated MCID to a BS where the user terminal is located; and
receiving a service initiation response message from the BS.

12. An apparatus for providing a news service in a wireless access system, the apparatus comprising:
a newsgroup server for, if a user terminal has joined at least one newsgroup, transmitting a message for notifying a Multicast and Broadcast Service Controller (MBSC) of a newsgroup subscription of the user terminal, receiving news contents from a news provider corresponding to the at least one newsgroup, creating the received news contents into one packet, and transmitting the resulting news packet to the MBSC in real time or at a predetermined period of time; and
the MBSC for allocating a newsgroup dedicated Multicast Connection ID (MCID) to the user terminal upon receiving a message for notifying the newsgroup subscription of the user terminal from the newsgroup server, receiving the news contents created into one packet from the newsgroup server, and multicasting the received news contents to the user terminal through an MCID.

13. The apparatus of claim 12, further comprising the user terminal transmitting a newsgroup list request message to the newsgroup server,
wherein upon receiving the newsgroup list request message, the newsgroup server transmits a newsgroup list response message including an available newsgroup list to the user terminal.

14. The apparatus of claim 13, wherein the user terminal selects at least one newsgroup from the newsgroup list and transmits a subscription request message for the selected newsgroups to the newsgroup server, and the newsgroup server adds the user terminal to a subscriber list of the corresponding newsgroup upon receiving the subscription request message.

15. The apparatus of claim 12, wherein the newsgroup server receives a news update message for uploading news contents from the news provider before receiving the news contents.

16. The apparatus of claim 12, wherein the newsgroup server transmits a news update message for uploading news contents to the MBSC the before the transmission of the created news packet to the MBSC.

17. The apparatus of claim 12, wherein before the multicast of the received news contents, the MBSC packetizes the received news contents into a packet of a predetermined size and performs a time synchronization between Base Stations (BSs).

18. The apparatus of claim 12, wherein before the multicast of the received news contents, the MBSC transmits a burst allocation request message to the BS in order to allocate resources for transmitting the received news contents to the user terminal and receives a burst allocation response message from the BS.

19. The apparatus of claim 12, wherein the MBSC transmits a service initiation request message including the allocated MCID to a BS where the user terminal is located

20. The apparatus of claim 19, further comprising the BS establishing an MBS connection with the user terminal using the MCID upon receiving the service initiation request message.

21. The apparatus of claim 20, wherein the MBS connection is a channel is a newsgroup dedicated channel that is used to provide all news contents to the corresponding user terminal through one MCID without establishing connections with each newsgroup.

22. A method for providing a news service from a newsgroup server in a wireless access system, the method comprising:
transmitting a message for notifying a Multicast and Broadcast Service Controller (MBSC) of a newsgroup subscription of a user terminal;
receiving news contents from a news provider corresponding to the newsgroup subscription; and
creating the received news contents into one packet and transmitting the resulting packet to the MBSC.

23. An apparatus for providing a news service from a newsgroup server in a wireless access system, the apparatus comprising:
means for transmitting a message for notifying a Multicast and Broadcast Service Controller (MBSC) of a newsgroup subscription of a user terminal;
means for receiving news contents from a news provider corresponding to the newsgroup subscription; and
means for creating the received news contents into one packet and transmitting the resulting packet to the MBSC.
